(19) United States
(12) Patent Application Publication
(10) Pub. No.: US 2019/0017680 A1
(43) Pub. Date: Jan. 17, 2019

(54) EXTERNAL OPERATION OF SEALED LIGHT FIXTURE USING MAGNETIC FORCE

(71) Applicant: Harman Professional Denmark ApS, Aarhus N. (DK)

(72) Inventor: Niels Jørgen Rasmussen, Egaa (DK)

(21) Appl. No.: 16/030,786

(22) Filed: Jul. 9, 2018

(30) Foreign Application Priority Data
Jul. 11, 2017 (DK) PA 2017 70564

(51) Int. Cl. F21V 14/00

(52) U.S. Cl. CPC F21V 14/00

(57) ABSTRACT

A light fixture comprising a sealed housing, where at least one light source is arranged. The light source generates a light beam propagating along an optical axis and exiting the sealed housing through a light beam window. At least one light beam modifying element is configured to modify the light beam and is connected to an adjustment mechanism inside the sealed housing. The adjustment mechanism comprises a magnetic element mechanically connected to the light beam modifying element and the adjustment mechanism is configured to move the light beam modifying element in relation to the light beam when an external magnetic field is applied to the magnetic element from outside of said sealed housing.

### CROSS-REFERENCE TO RELATED APPLICATIONS

This application claims the priority of co-pending Danish patent application titled, “EXTERNAL OPERATION OF SEALED LIGHT FIXTURE USING MAGNETIC FORCE” filed on Jul. 11, 2017 and having Serial No. PA 2017 70564. The subject matter of this related application is hereby incorporated herein by reference

### FIELD OF THE INVENTION

The present invention relates to a light fixture with a sealed housing, at least one light source, at least one light beam modifying element and a method for moving the light beam modifying element using magnetic fields.

### BACKGROUND OF THE INVENTION

In order to create various light effects and mood lighting in connection with concerts, live shows, TV shows, sport events or as a part of an architectural installation, light fixtures creating various effects are getting more and more used in the entertainment industry. Typically entertainment light fixtures creates a light beam having a beam width and a divergence and can for instance be wash/flood fixtures creating a relatively wide light beam with a uniform light distribution or it can be profile fixtures adapted to project image onto a target surface.

Typically such light fixtures comprise at least one light source generating a light beam propagating along an optical axis and an optical assembly configured to project the light beam along the optical axis. Light fixtures for architectural installation can comprise a number of light effect components which is configured to be inserted into the light beam in order to provide different light effects. The light effect components can be any light effect components known in the art of intelligent/entertainments/architectural lighting for instance, a CMY color mixing system, color filters, gobos, animation effects wheels, a iris diaphragms, a focus lenses, zoom lenses, prism effect components, framing systems or any other light effect components known in the art.

In order to maximize the lifetime of fixed installation lighting fixtures used in for example architectural installations the lighting fixtures often comprise sealed housings to protect the equipment from the surrounding environment for instance by preventing dust and moist from entering the light fixture. An adjustment of the lighting fixture can be necessary during installation in order to illuminate the target surface properly for instance by using zoom lenses, focus lenses, barn doors or CMY-filters or certain lighting effects might be wanted during different seasons like color filters or gobos. These adjustment are only performed rarely and sometimes even just once in the lifetime of the product. In some embodiments of fixed installation lighting fixtures these adjustments can only be made by opening the sealed housing and thereby potentially contaminating the interior of the lighting fixture with moist and/or dust from the surrounding environment which potentially can cause a degradation of the equipment. Some fixed installation lighting fixtures overcome this by providing actuators to perform the adjustments inside the hermetically sealed fixture. The actuators are then controlled from the outside of the housing without breaking the seal, either by using a wireless connection or using buttons that do not penetrate the sealing. The actuator-based solution is however expensive to implement and can cause the system to become more complicated than necessary and thereby increasing costs of the light fixture. Additional the actuator based solution do also require some kind of communication device which can communicate with the actuators inside the light fixture and the technicians installing the light fixtures need thus to bring the communication device which is not always possible e.g. due physical surroundings where the light fixture is to be installed, to weather conditions or other restrictions preventing such communication device.

### DESCRIPTION OF THE INVENTION

The object of the present invention is to provide a new lighting fixture for fixed installations which overcomes the limitations described above. This is achieved by a light fixture comprising a sealed housing with at least one light source arranged inside the housing as mentioned in the independent claims. The light source is generating a light beam, and the light beam propagates along an optical axis and exits the housing through a light beam window. The light fixture further comprises at least one light beam modifying element configured to modify the light beam. The light beam modifying element is connected to an adjustment mechanism inside the housing and the adjustment mechanism comprises a magnetic element which is mechanically connected to the light beam modifying element. The adjustment mechanism is configured to move the light beam modifying element in relation to the light beam when an external magnetic field is applied to the magnetic element from outside of the sealed housing.

The sealed housing can be any housing with an interior, wherein the light source and the optical components are arranged, that is isolated from the surrounding environment preventing dust and moist from the outside environment to enter. In one embodiment the housing may be hermetically sealed from the surround environment. For instance the seal housing may have IP (Ingress Protection) rating 66, 67 or 68.

The light source arranged inside the sealed housing can be any light source used in area of entertainment and architectural lighting, including, but not limited to, incandescent lamps, discharge lamps, plasma lamps, LEDs, OLEDs, PLEDS, etc. or any combination thereof. It is also understood that any number of light sources can be used.

The light beam window in the sealed housing can be any component allowing the light beam to be emitted from the housing, including, but not limited to, optical lenses, clear glass, colored glass, etc. or any combination thereof.

The light beam modifying element arranged inside the sealed housing can be any element capable of modifying the light beam as known the area of intelligent, entertainment, and architectural lighting, including, but not limited to, optical lenses, barn doors, color wheels, color correction flags, animation effect wheels, iris diaphragms, prisms, gobos, dimmer flags, etc.

The adjustment mechanism arranged inside the housing can be any mechanical device configured to move the light beam modifying element in relation to the light beam. It can be any combination of rods, gears, and plates.

The magnetic element is attached to the adjustment mechanism and is configured to interact with an external magnetic field outside of the sealed housing. The magnetic element can be any material with magnetic properties, including, but not limited to, iron, nickel, and magnetite. The magnetic element can also be a permanent magnet or an electromagnet.

The external magnetic field located outside the sealed housing is applied close to the magnetic element located on the inside of the housing. The magnetic field can be produced in any known way to producing magnetic fields, including, but not limited to, permanent magnets and electromagnetism. For instance as an external permanent which can be rotated by a screwdriver

The light fixture makes it possible to keep the light source and the beam modifying element sealed from the external environment and preventing contamination which can lower the quality of the light beam or the internal components. The life of the light fixture can potentially be extended because a contamination can shorten the life of the components in light fixture. The above elements can be made by cheap components and are simple to implement which lowers the price of manufacturing the light fixture. This is achieved as the beam modifying elements can be easily moved in relation to each other by applying the magnetic force to the outside of the light fixture resulting in the fact the beam modifying element can be moved without opening or breaking the seal of the sealed housing.

In one embodiment the adjustment mechanism is rotatable around a rotation axis, and the external magnetic field causes the magnetic element to rotate around the rotation axis when the external magnetic field is rotated around the rotation axis. The rotation of the magnetic element causes, the light beam modifying element to move in relation to the light beam. This makes it possible in a simple way to apply the external magnetic force to the magnetic element for instance by using a screwdriver rotating an external permanent magnet.

The rotational movement of the adjustment mechanism allows different light beam modifying elements to move in relation to the light beam. An example can be changing the color in a color wheel by rotating the wheel. In a different example the rotational movement of the adjustment mechanism can be used to rotate a threaded rod which is configured to move the light beam modifying element along a translation axis. In yet another example the rotational movement of the adjustment mechanism can be used to rotate the light beam modifying element around the optical axis. This can for example be used to rotate a gobo or a prism. One should notice that these are only examples and that any light beam modifying elements that uses rotational movement can be implemented.

In another embodiment the magnetic element is movable along a translation axis inside the sealed housing, and the external magnetic field causes the magnetic element to move along the translation axis when the magnetic field is moved along the housing. The movement of the magnetic element causes the light beam modifying element to move in relation to the light beam.

The translational movement of the adjustment mechanism allows different light beam modifying elements to move in relation to the light beam. An example can be a zoom-lens or a focus-lens moving back and forth in the light beam along the optical axis. In a different example the translational movement of the adjustment mechanism is used to move internal barn doors or dimmers in relation to the light beam and perpendicular to the optical axis. One should notice that these are only examples of implementations and that any light beam modifying elements that uses translational movement can be implemented.

In one embodiment the external magnetic field is provided by a permanent magnet. The use of a permanent magnet is a cheap solution and allows for a strong coupling with the magnetic element inside the sealed housing.

In one embodiment the permanent magnet is movable attached to the housing.

The movable attachment allows the magnetic field of the permanent magnet to move the magnetic element on the inside of the housing. The external magnetic field can either be provided as a detachable or a non-detachable solution.

In one embodiment the external permanent magnet outside the housing is rotatable attached to the housing.

The rotatable attachment allows the magnetic field of the external permanent magnet to provide a rotating magnetic field, which is used to rotate the magnetic element inside of the housing.

In another embodiment the external permanent magnet outside of the housing is attached movable along a translation axis to the housing.

The translational attachment allows the magnetic field of the external permanent magnet to provide a translational movement of the magnetic field along the housing, which can be transferred to the magnetic element inside the housing.

In one embodiment the external permanent magnet outside the housing is enclosed in a second housing.

The second housing is provided to protect the external permanent magnet on the outside of the housing from the surrounding environment and to provide a more comfortable grip for the user.

In one embodiment a spring is configured to press the magnetic element towards the inner side of the light fixture housing. This ensures that the magnetic element is arranged as close to the light fixture housing as possible which thereby providing a good magnetic contact between the external magnetic force and magnetic element.

The present invention describes a method of moving a beam modifying element inside a light fixture as mentioned in the independent claims, where the light fixture comprises a sealed housing, at least one light source arranged in the sealed housing and the light source generates a light beam. The light beam propagates along an optical axis and exits the sealed housing through a light beam window in the housing. The at least one light beam modifying element is connected to an adjustment mechanism inside the housing. The adjustment mechanism comprises a magnetic element mechanically connected to the light beam modifying element. The method comprises the steps of applying an external magnetic force to the exterior side of the sealed housing and at a position where the external magnetic force magnetically interacts with said magnetic element; moving the magnetic element inside the housing by moving the external magnetic force in relation to the sealed housing.

The above method allows for movement of a beam modifying element without breaching the seal of the housing and thereby prevents moist and dust from the surrounding environment to enter the light fixture. The method can be implemented in a very intuitive way as the user can almost directly move the light beam modifying element from the outside of the housing.

The present invention further describes a method where the moving of the magnetic element inside the sealed housing comprises the steps of rotating the external magnetic force around a rotation axis in relation to the housing. The external magnetic force interacts with the magnetic element causing the magnetic element to rotate around the rotation axis. The rotation of the magnetic element around the rotation axis causes the light beam modifying element to move in relation to the light beam.

The above method allows for a rotational movement of the magnetic element without breaching the seal of the sealed housing and thereby prevents moist and dust from the surrounding environment to enter the light fixture. The rotational movement of the magnetic element can be translated to a rotational movement of the beam modifying element used for various tasks like rotating a color wheel, prism, or gobo wheel, or inserting or removing color correction filters or dimmers. The rotational movement of the magnetic element can also be translated to a translational movement of the light beam modifying element for example by use of a threaded rod. The translational movement of the light beam modifying element can then be used to move different optical elements like zoom- and focus lenses back and forth along the optical axis. The mentioned tasks are meant as examples and a person skilled in the art of entertainment and architectural lighting can come up with several others uses for the rotational and translational movement of a light beam modifying element.

The invention further describes a method where the moving of the magnetic element inside the sealed housing comprises the steps of moving the external magnetic force along a translation axis in relation to the housing. The external magnetic force interacts with the magnetic element causing the magnetic element to move along the translation axis. The movement of the magnetic element along the translation axis causes the light beam modifying element to move in relation to the light beam.

The above method allows for a translational movement of the magnetic element without breaching the seal of the housing and thereby prevents moist and dust from the surrounding environment to enter the light fixture. The translational movement of the magnetic element can be translated directly to a translational movement of the light beam modifying element which can be used for various tasks like moving different optical elements like zoom- and focus lenses along the optical axis. It can also be used to move barn doors or dimmers perpendicular to the optical axis inside the light fixture. The mentioned tasks are meant as examples and a person skilled in the art of entertainment and architectural lighting can come up with several others uses for the translational movement of a light beam modifying element.

### DESCRIPTION OF THE DRAWING

FIG. 1 illustrates a simplified embodiment of the lighting fixture with an adjustment system according to the present invention;

FIG. 2 illustrates a light fixture according to the present invention where an external permanent magnet is arranged outside of the sealed housing;

FIG. 3 illustrates a light fixture embodiment with a rotatable light beam modifying element;

FIG. 4 illustrates a light fixture embodiment with a light beam modifying element rotating around the optical axis;

FIG. 5 illustrates a light fixture embodiment with a rotatable light beam modifying element using gears;

FIG. 6 illustrates a light fixture embodiment where the light beam modifying elements move along a translation axis by an external magnetic field;

FIG. 7 illustrates the light fixture with a combination of two different adjustment systems and light beam modifying elements;

FIG. 8 illustrates an embodiment with a first and a second adjustment mechanism which are identical but mirrored around the optical axis;

FIG. 9 illustrates an embodiment including a center sun gear;

FIG. 10 illustrate a light fixture where a spring forces a magnetic element toward the inner wall of the sealed housing;

FIG. 11a-11b illustrates a load mechanism forcing a magnetic element towards the inner wall of the sealed housing.

### DETAILED DESCRIPTION OF THE INVENTION

The present invention is described in view of exemplary embodiments only intended to illustrate the principles of the present invention. The skilled person will be able to provide several embodiments within the scope of the claims. In the illustrated embodiments the illustrated elements, light beams and optical means do only serve to illustrate the principles of the invention rather than illustrating exact and precise elements, light beams and optical means. Throughout the description the reference numbers of similar elements providing similar effects have the same last two digits.

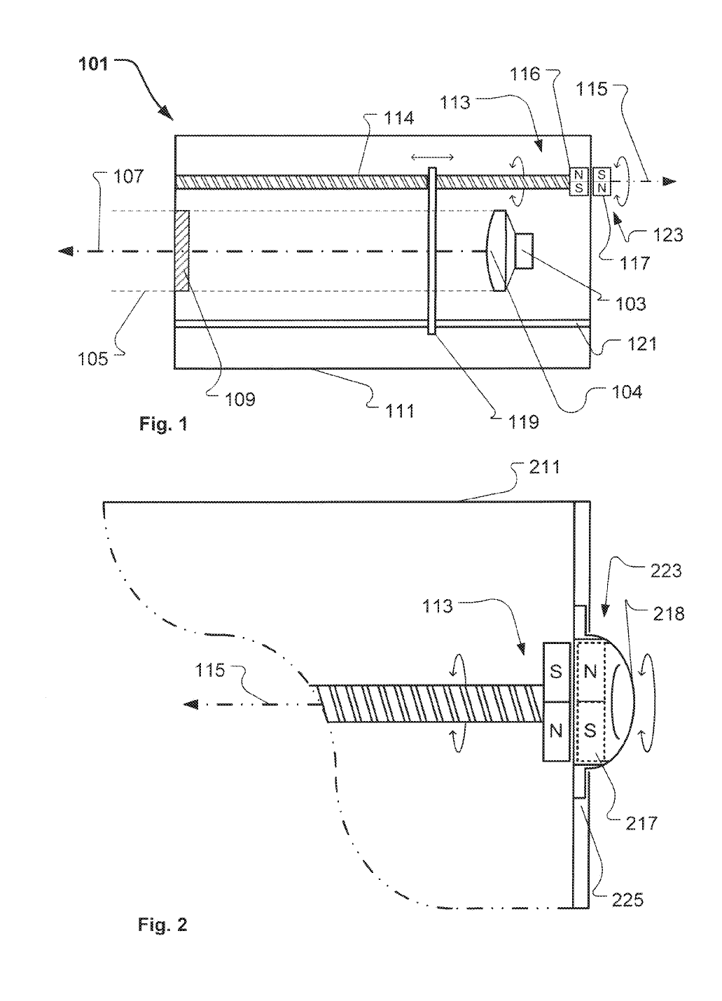

FIG. 1 illustrates a structural diagram of a light fixture 101 comprising a light source 103 arranged inside a sealed housing 111. The light source generates a light beam 105 propagating along an optical axis 107 exiting the housing through a light beam window 109. The light beam window can be provided as any component allowing the light beam to be emitted from the housing, such as optical lenses or clear glass or other optical transparent materials. The sealed housing means that the interior of the housing, wherein the light source and optical components are arranged, is isolated from the surrounding environment in that dust and moist is prevented from entering the housing or in another embodiment the housing may by hermetically sealed from the surrounding environment. The housing may for instance fulfill the IP rating 66, 67 or 68.

The light source can be any known light source for instance incandescent lamps, discharge lamps, plasma lamps, LEDs, OLEDs, PLEDs, etc. or any combination thereof. It is also understood that any number of light sources can be used. In FIG. 1 the light source 103 is illustrated as a LED with a light collecting lens 104 is configured to collect light form the LED and convert the collected light into the light beam.

The light fixture further comprises an adjustment mechanism 113 which is rotatable mounted within the sealed housing 111. In this illustration the adjustment mechanism comprises of a threaded rod 114 and a magnetic material 116 attached to one end of the rod. The magnetic material can be any material with magnetic capabilities including but not limited to any ferromagnetic materials and rare earth magnets.

A light beam modifying element 119 is connected to the adjustment mechanism and configured to move along the optical axis 107 as the adjustment mechanism rotates around the rotation axis 115. A rotation mechanism 123 including a permanent magnet 117, which is either removable attached or permanent attached on the outside of the housing, is configured to rotate around the rotation axis. When the rotation mechanism is rotated the magnetic field of the permanent magnet causes the adjustment mechanism to follow the rotation mechanism which moves the light beam modifying element along the optical axis. In this embodiment a guidance rod 121 is implemented to prevent the light beam modifying element from rotating along with the adjustment mechanism.

The light beam modifying element 119 can be any element capable of modifying the light beam including but limited to optical lenses, gobos, prisms, color wheels, CMY filters, barn doors etc.

FIG. 2 illustrates a close up on a rotation mechanism 223 where a permanent magnet 217 is placed inside a sealed enclosure 218 to protect the magnet from the environment. The rotation mechanism is mounted on the outside of the sealed housing 211 and in this embodiment the rotation mechanism is placed within a guiding cavity 225 to ensure that the rotation mechanism is permanently attached to the housing. However, it should be noticed that in another embodiment the rotation mechanism can also be implemented as a detachable mechanism. The rotation mechanism can also be implemented as a permanent magnet mounted on a screwdriver which rotates the permanent magnet, or the magnetic field can be provided by an electromagnetic device.

The adjustment mechanism 113 is rotatable attached to the housing and is configured to rotate around the rotation axis 115. When the rotation mechanism 223 is rotated around the rotation axis the magnetic field from the permanent magnet causes the adjustment mechanism to follow the rotation.

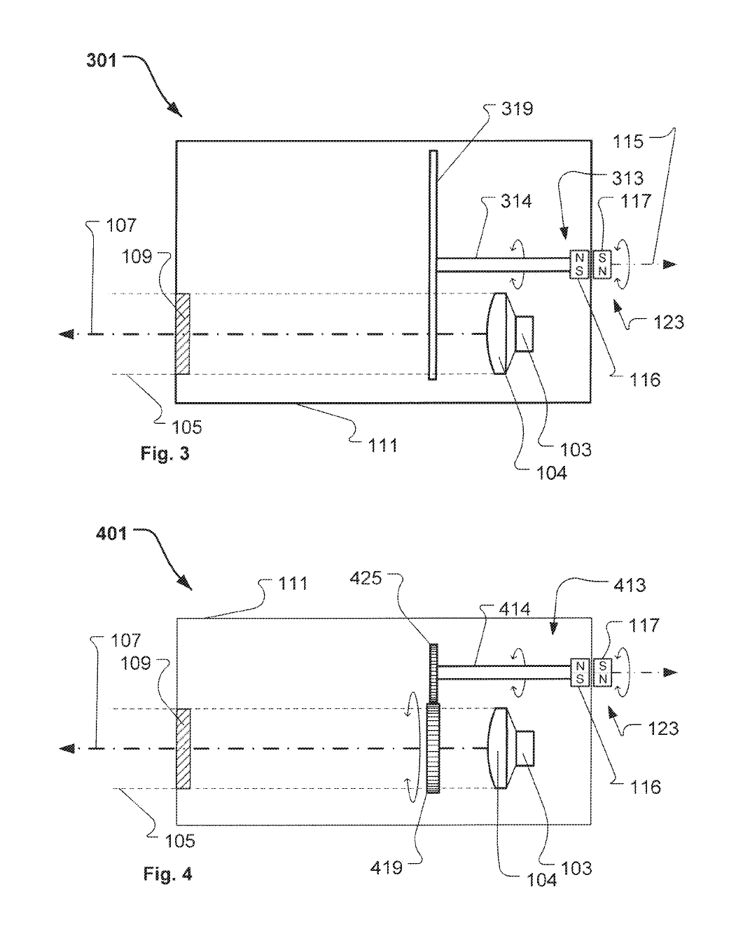

FIG. 3 illustrates a different embodiment of the fixed installation lighting fixture 301. The lighting fixture comprises a light source 103 and corresponding light collecting lens 104 arranged within a sealed housing 111. The light source generates a light beam 105 propagating along an optical axis 107 exiting the housing through a light beam window 109.

The light fixture further comprises an adjustment mechanism 313 which is rotatable mounted within the housing 111. In this illustration the adjustment mechanism comprises of a rod 314 and a magnetic material 116 attached to one end of the rod. The rod is connected to a light beam modifying element 319 and when the adjustment mechanism is rotated around the rotation axis 115 the light beam modifying element is also rotating. A rotation mechanism 123 including a permanent magnet 117 is arranged on the outside of the housing and is configured to rotate around the rotation axis 115. When the rotation mechanism is rotated the magnetic field of the permanent magnet causes the adjustment mechanism to follow the rotation mechanism which rotates the light beam modifying element around the rotation axis. In this embodiment the light modifying element can be provided as a color wheel or gobo wheel where a number of color filters or gobos are arranged around the center of the wheel. Also the light beam modifying element can be provided as dimmer flags, CMY flags, frost flags which when rotated around the axis 115 are moved inside the light beam in order to gradually change the dimmer, color or frost effect.

FIG. 4 illustrates an embodiment of the fixed installation lighting fixture 401 where the light beam modifying element 419 has teeth around the circumference to act as a gear allowing the light beam modifying element to rotate around the optical axis 107.

The adjustment mechanism 413 is rotatable mounted within the housing 111. In this embodiment the adjustment mechanism comprises of a rod 414, a magnetic material 116 attached to one end of the rod, and a gear 425 attached to the opposite site of the rod. Rotation of the adjustment mechanism causes the light beam modifying element 419 to rotate around the optical axis 107. A rotation mechanism 123 comprising a permanent magnet 117 is arranged on the outside of the housing and is configured to rotate around the rotation axis 115. When the rotation mechanism is rotated the magnetic field of the permanent magnet causes the adjustment mechanism to follow the rotation mechanism which rotates the light beam modifying element around the optical axis. The rotation mechanism can be provided as described above. The gearing may be configured such that the force needed to rotate the rod 414 using the internal magnetic element is as small as possible. This can for instance be achieved by designing the first toothed wheel 425 with a smaller amount of teeth than the teeth around the circumference of the light beam modifying element.

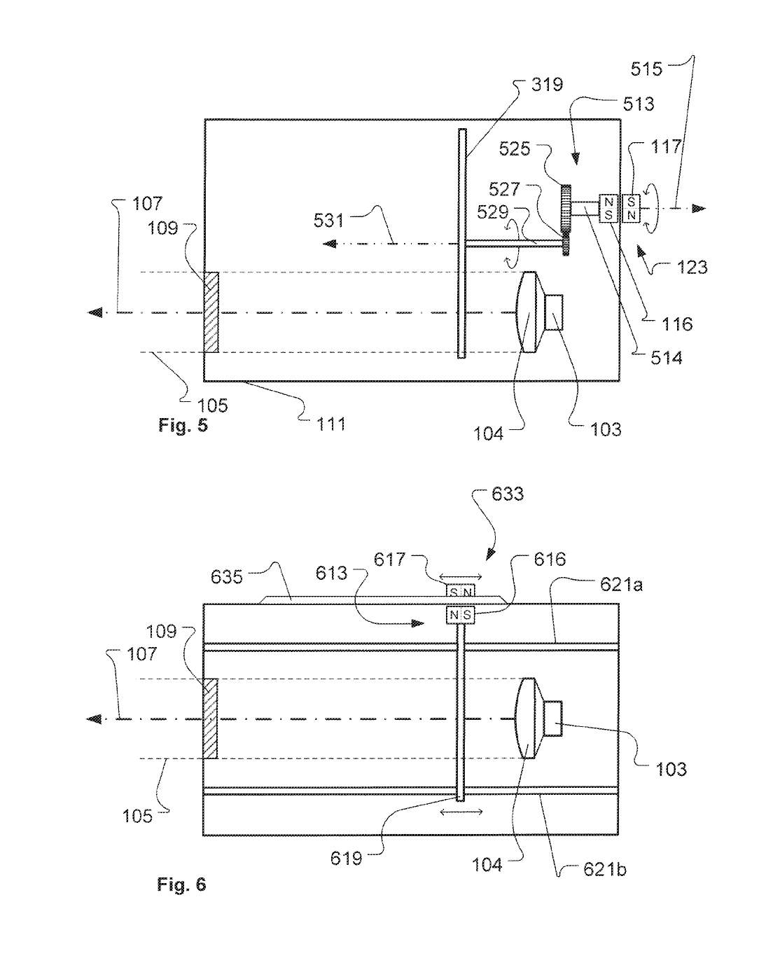

FIG. 5 illustrates an embodiment similar to the embodiment described in FIG. 3; however, this embodiment includes gearing.

The adjustment mechanism of this embodiment comprises a primary rod 514 with a magnetic material attached to one end 116 and a primary gear 525 attached to the other end. The primary gear of the adjustment mechanism interacts with a secondary gear 527 causing a secondary rod 529 to rotate at a speed different from that of the primary rod. The secondary rod is connected to a light beam modifying element 319 which rotates along a secondary rotation axis 531.

A rotation mechanism 123 comprising a permanent magnet 117 is rotatable mounted on the outside of the sealed housing 111. When the rotation mechanism is rotated around a first rotation axis 515, the magnetic field causes the adjustment mechanism to follow the rotation. In this embodiment the primary gear is larger than the secondary gear causing the light beam modifying element to have a faster rotational speed than that of the rotation mechanism; however it should be noted that any type of gearing can be used depended on the desired effect.

FIG. 6 illustrates an embodiment of the invention where the light beam modifying element is moved back and forth along the optical axis.

The adjustment mechanism 613 of this embodiment comprises a magnetic material 616 connected to a light beam modifying element 619. The adjustment mechanism is able to move back and forth along the optical axis 107 controlled by some guiding rods 621a, 621b.

A sliding mechanism 633 is provided on the outside of the sealed housing 111, and comprises a permanent magnet 617 and a guiding rail 635. When the sliding mechanism is used, the permanent magnet is moved along the housing and the magnetic field of the permanent magnet causes the adjustment mechanism 613 to follow the permanent magnet along the guiding rods causing the light beam modifying element to move along optical axis 107.

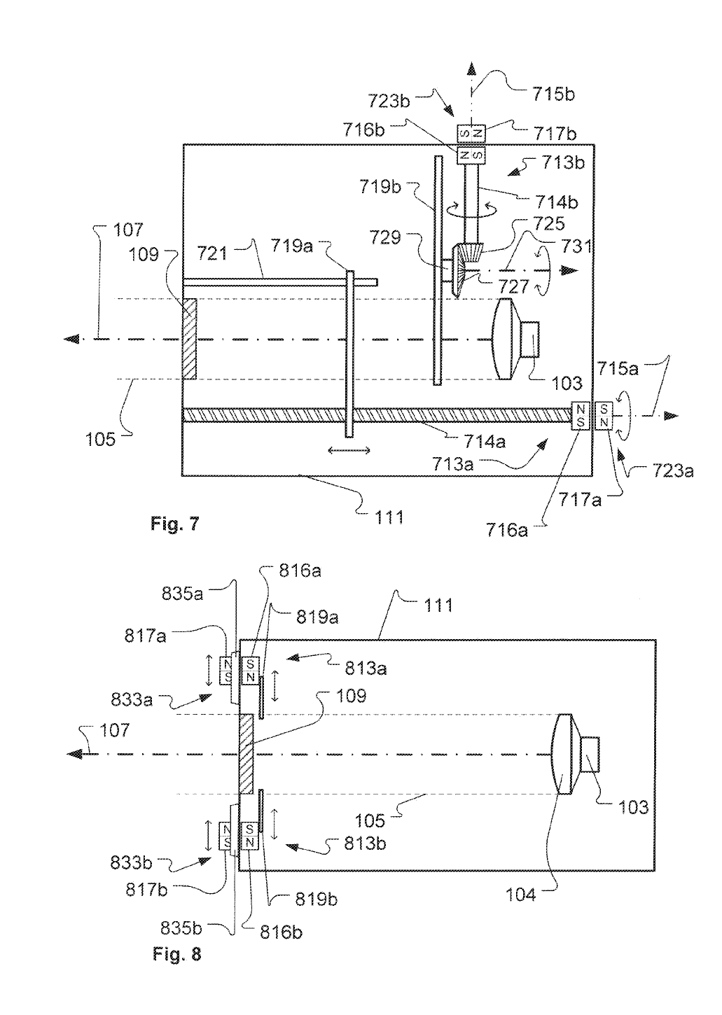

FIG. 7 illustrates an embodiment comprising a first and a second adjustment mechanism. The first adjustment mechanism 713a is similar to that of FIG. 1, while the second adjustment mechanism 713b shares some similarities with the adjustment mechanism of FIG. 5.

The first adjustment mechanism 713a of this embodiment comprises a magnetic material 716a attached to a threaded rod 714a which is connected to a first light beam modifying element. A first rotation mechanism 723a is rotatable mounted on the outside of the sealed housing 111 adjacent to the magnetic material 716a of the first adjustment mechanism. The first rotation mechanism comprises a permanent magnet 717a and is rotatable around a first primary translation axis 715a. When the first rotation mechanism is rotated around the first primary axis, the magnetic field of the permanent magnet influence the magnetic material 716a of the first adjustment mechanism causing it to follow the rotation which is translated to a back and forth movement of the first light beam modifying element 719a along the optical axis 107. In this embodiment a guidance rod 721 is provided to prevent the first light beam modifying element to rotate along with the threaded rod 714a.

The second adjustment mechanism 713b of this embodiment comprises a magnetic material 716b attached to a second primary rod 714b which is connected to a primary gear 725. The second adjustment mechanism is rotatable around a second primary rotation axis 715b and the primary gear is coupled with a secondary gear 727 which rotates around a second rotation axis 731. The secondary gear is connected to a secondary rod 729 which is connected to a second light beam modifying element 719b.

A second rotation mechanism 723b similar to that of FIG. 2 is rotatable attached to the outside of the sealed housing 111 adjacent to the second adjustment mechanism 713b. The second rotation mechanism comprises a second permanent magnet 717a and is rotatable around a second primary rotation axis 715b. When the second rotation mechanism is rotated around the second primary axis, the magnetic field of the permanent magnet influence the magnetic material 716b of the second adjustment mechanism causing it to follow the rotation which is translated to a rotation of the second light beam modifying element around a second rotation axis 731.

FIG. 8 illustrates an embodiment with a first and a second adjustment mechanism which are identical but mirrored around the optical axis 107.

The first adjustment mechanism 813a contains a magnetic element 816a and is connected to a first light beam modifying element 819a. The first adjustment mechanism is moveable perpendicular to the optical axis 107. A first sliding mechanism 833a comprises a permanent magnet 817a which can be moved back and forth in a guiding rail 835a. When the first sliding mechanism is moved back and forth in the guiding rail the magnetic element of the first adjustment mechanism follows the permanent magnet and thereby moves the light beam modifying element in and out of the light beam.

The second adjustment mechanism 814b comprises a magnetic element 816a and is connected to a second light beam modifying element 819b. The second adjustment mechanism is movable perpendicular to the optical axis 107. A second sliding mechanism 833b contains a permanent magnet 817b which can be moved back and forth in a guiding rail 835a. When the second sliding mechanism is moved back and forth in the guiding rail the magnetic element of the second adjustment mechanism follows the permanent magnet and thereby moves the second light beam modifying element in and out of the light beam.

In this embodiment the beam modifying elements can be a framing systems configured to shape the light beam 105 before it exits the housing through the light beam window 109. It can also be dimmers configured to gradually dim the light beam as they are gradually inserted into the light beam. These are just examples and a person skilled in the area will be able to come up with several other beam shaping elements.

In the above embodiment the beam shaping elements are perpendicular to the optical axis; however it should be noted that any angle can be provided to obtain various effects.

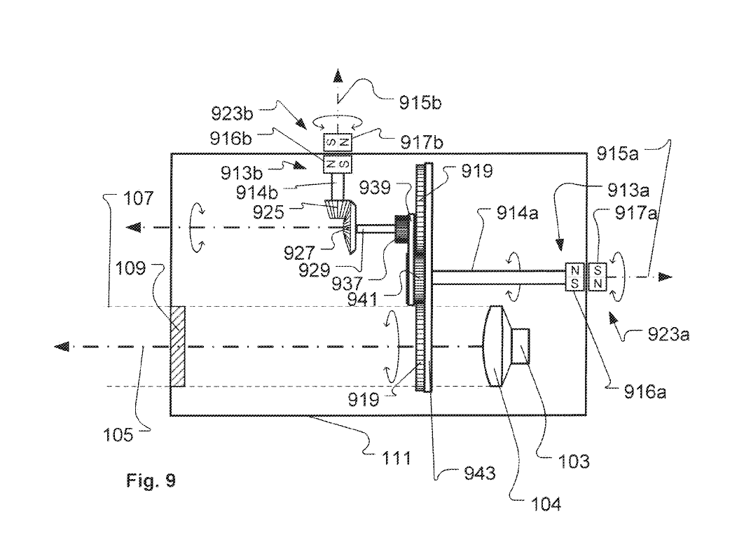

FIG. 9 illustrates an embodiment including a center sun gear for instance by not limited to the ones described in U.S. Pat. No. 6,601,973, U.S. Pat. No. 790,563, and U.S. Pat. No. 7,222,997.

A first adjustment mechanism comprises a rod 914a where, in one end, a magnetic element 916a is attached and in the other end a baseplate 943 is connected. The baseplate has a plurality of light beam modifying element 919 rotatable attached thereon. The baseplate further comprises a center gear 941 rotatable attached thereon.

A first rotation mechanism 923a is rotatable attached to the outside of the sealed housing 111. The first rotation mechanism comprises a permanent magnet 917a and is able to rotate around a first rotation axis 915a. When the rotation mechanism is rotated around the first rotation axis the first adjustment mechanism follows the permanent magnet and the base plate containing a plurality of beam modifying elements is rotated inside the light beam 107.

A second adjustment mechanism 913b comprising of a primary rod 914b, a magnetic material 916b attached to one end, and a primary gear 925 attached to the other end, and a secondary rod 929 which has secondary gear 927 connected to one end and a tertiary gear 937 connected to the other end, and a belt 939 connected from the tertiary gear to the center gear 941 on the base plate 943.A second rotation mechanism 923b is rotatable attached to the outside of the sealed housing 111. The second rotation mechanism comprises a permanent magnet 917b and is able to rotate around a second rotation axis 915b. When the rotation mechanism is rotated around the second rotation axis the second adjustment mechanism follows the rotation mechanism, causing the center gear 941 to rotate which rotates the plurality of beam modifying elements 919.

It should be noted that the gearing in this embodiment is just an example and the center sun gearing can be implemented in several other ways to obtain the same effect. It should also be noted that rotation of the light beam modifying elements on the base plate can be implemented in several other ways.

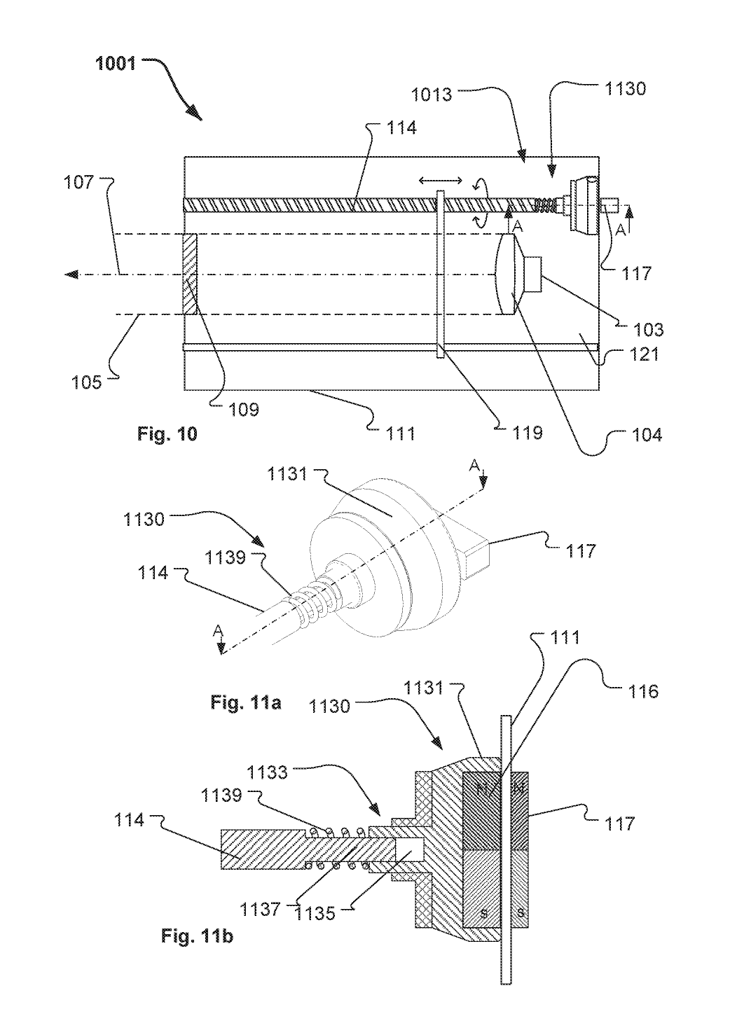

FIG. 10 illustrates a structural diagram of a light fixture 1001 similar to the light fixture illustrated in FIG. 1 and like elements have been provided the same reference numbers and will not be described further. In this embodiment the adjustment mechanism 1013 comprises a load mechanism 1130 configured to push the magnetic element of the adjustment mechanism towards the inner wall of the sealed housing. This ensures that the magnetic element is as close to the seal housing as possible whereby the magnetic interaction between the magnetic element and the external magnetic force is increased. The load is illustrated in FIGS. 11a-11b.

FIGS. 11a and 11b illustrate the load mechanism of the light fixture 1001 illustrated in FIG. 10, where FIG. 11a illustrates a perspective view and FIG. 11b illustrates a cross sectional view through line A-A. The load mechanism comprise a housing 1131 configured to accommodate a magnetic element 1116 comprising a north pole N and a south pole S. The housing is connected to the threaded rod 114 via a mating mechanism 1133. In the illustrate embodiment the mating mechanism 1133 is formed as an accommodating hole 1135 in the housing which configured to receive and accommodate a mating rod 1135 of the threaded rod. The cross sectional shape of the accommodating hole and the mating rod is provided with a non-circular shape whereby rotation of the housing causes rotation of the threaded rod. The cross section may for instance be polygonal, cross shaped, star shaped or any other non-circular form. A spring 1139 is provided in order to push the housing towards the inner wall of the sealed housing 111 (not shown in FIG. 11a). The spring is provided around the mating rod and pushes the housing 1131 away from the threaded rod 114 and the adjustment mechanism is thus mounted in a tense state of the spring. It noted that accommodating hole can be provided at the threaded rod 114 and the mating rod then can be provided at the housing. Additionally it is noted that the spring alternatively can be arranged inside the accommodating hole. It is also noticed that the load mechanism illustrated in FIGS. 11a-11b can be integrated in any of the light fixtures illustrated in the drawings.

1. A light fixture comprising:
a sealed housing, said sealed housing comprising at least one light source arranged in said sealed housing, said light source generating a light beam, said light beam propagates along an optical axis and exits said sealed housing through a light beam window in said sealed housing; and
at least one light beam modifying element configured to modify said light beam; said light beam modifying element is connected to an adjustment mechanism inside said sealed housing;
wherein said adjustment mechanism comprises a magnetic element mechanically connected to said light beam modifying element and said adjustment mechanism is configured to move said light beam modifying element in relation to said light beam when an external magnetic field is applied to said magnetic element from outside of said sealed housing.

2. The light fixture according to claim 1, wherein said adjustment mechanism is rotatable around a rotation axis, and said external magnetic field causes said magnetic element to rotate around said rotation axis when said external magnetic field is rotated around said rotation axis, said rotation of said magnetic element causes said light beam modifying element to move in relation to said light beam.

3. The light fixture according to claim 1, wherein said magnetic element is movable along a translation axis inside said sealed housing, and said external magnetic field causes said magnetic element to move along said translation axis when said magnetic field is moved along said sealed housing; said movement of said magnetic element causes said light beam modifying element to move in relation to said light beam.

4. The light fixture according to claim 1, wherein said external magnetic field is provided by an external permanent magnet attached to said sealed housing.

5. The light fixture according to claim 4, wherein said external permanent magnet is rotatable attached to said sealed housing.

6. The light fixture according to claim 4, wherein said external permanent magnet is attached movable along a translation axis to said sealed housing.

7. The light fixture according to claim 4, wherein said permanent magnet outside said sealed housing is enclosed in a second exterior housing arranged at the exterior of said seal housing.

8. The light fixture according to claim 1, wherein said adjustment mechanism comprises a load mechanism configured to force said magnetic element towards the inner wall of said sealed housing.

9. The light fixture according to claim 8, wherein said load mechanism comprises a spring configured to push said magnetic element towards the inner wall of said sealed housing.

10. A method of moving a beam modifying element inside a light fixture, said light fixture comprising:
a sealed housing, said sealed housing comprising at least one light source arranged in said sealed housing, said light source generating a light beam, said light beam propagates along an optical axis and exits said sealed housing through a light beam window in said sealed housing; and
at least one light beam modifying element configured to modify said light beam; said light beam modifying element is connected to an adjustment mechanism inside said sealed housing;
wherein said adjustment mechanism comprises a magnetic element mechanically connected to said light beam modifying element and said adjustment mechanism is configured to move said light beam modifying element in relation to said light beam when an external magnetic field is applied to said magnetic element from outside of said sealed housing, said method comprising the steps of:
applying an external magnetic force to the exterior side of said sealed housing at a position where said external magnetic force magnetically interacts with said magnetic element; and
moving said magnetic element inside said sealed housing by moving said external magnetic force in relation to said sealed housing.

11. The method according to claim 10, wherein said moving of said magnetic element inside said sealed housing comprises the step of rotating said external magnetic force around a rotation axis in relation to said sealed housing.

12. The method according to claim 10, wherein said moving of said magnetic element inside said sealed housing comprises the step of moving said external magnetic force along a translation axis in relation to said sealed housing.

13. The method according to any claim 10, wherein at least a part of said external magnetic force is applied using a permanent magnet.

14. The method according to claim 10, wherein at least a part of said external magnetic force is applied using an electro magnet.
